(19) United States
(12) Patent Application Publication
(10) Pub. No.: US 2013/0009902 A1
(43) Pub. Date: Jan. 10, 2013

(54) METHOD FOR STERILIZE-ABLE COMPUTER SYSTEM AND PERIPHERALS

(76) Inventor: Matthew Ross Darling, Canberra (AU)

(21) Appl. No.: 13/635,510

(22) PCT Filed: Mar. 16, 2011
(86) PCT No.: PCT/IB2011/001163

§ 371 Date: Sep. 17, 2012

Related U.S. Application Data
(60) Provisional application No. 61/314,259, filed on Mar. 16, 2010.

(51) Int. Cl. G06F 3/041

(52) U.S. Cl. 345/173

(57) ABSTRACT

Sterilizable systems and devices are provided. In one example, the device includes a touch screen comprising an outward facing surface, at least one processor operatively coupled to the touch screen, and a memory coupled to the at least one processor. The device may also include a casing configured to: enclose the at least one processor and the memory; partially enclose the touch screen while allowing an input portion of the outward facing surface to be outwardly exposed to receive user inputs; and taper toward the input portion to form a beveled frame around the outward facing surface, the beveled frame forming at least one waterproof seal with a covered portion of the outward facing surface.

### BACKGROUND

1. Field

The present application relates generally to computing devices, and more specifically to techniques for configuring devices for use in a sterile environment.

2. Background

Computer systems that can be used in sterile environments such as hospital surgery's, critical care and general wards has been a need for many years. Adaptation of computer systems from other industries such as underwater or waterproof capable computers or military grade computer systems have been used to limited success to fill the needs of health care professionals in sterile environments.

The use of waterproof computers does not address the computers ability to withstand intensive cleaning with powerful cleaning agents such as bleach. Also the general design of computers produce cracks and crevices in the computers casing and peripherals that hinder effective cleaning and sterilization allowing disease and infection to proliferate in equipment that is frequently in close proximity to patients thus producing considerable health risks. Accordingly, it would be desirable to address these issue by building a sterilization capable computer and peripheral system.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with an apparatus for use in a sterile environment. For example, the apparatus may include a touch screen comprising an outward facing surface, at least one processor operatively coupled to the touch screen, and a memory coupled to the at least one processor for storing data. The apparatus may further include a casing configured to: enclose the at least one processor and the memory; partially enclose the touch screen while allowing an input portion of the outward facing surface to be outwardly exposed to receive user inputs; and taper toward the input portion to form a beveled frame around the outward facing surface, the beveled frame forming at least one waterproof seal with a covered portion of the outward facing surface. In related aspects, the casing may be configured to dissipate heat by serving as a heat sink that transfers the heat from a first part to a second part of the casing.

In accordance with one or more embodiments and corresponding disclosure thereof, there is provided a system for sterile environments. For example, the system may include a touch screen device comprising an outward facing surface, as well as a casing. The casing may be configured to: partially enclose the touch screen device while allowing an input portion of the outward facing surface to be outwardly exposed to receive user inputs; and taper toward the input portion to form at least one beveled edge around the outward facing surface, the at least one beveled edge forming at least one waterproof seal with a covered portion of the outward facing surface.

In accordance with one or more embodiments and corresponding disclosure thereof, there is provided a casing or housing for a touch device or the like that may include a first portion configured to partially enclose the touch screen device while allowing an input portion of the device to be outwardly exposed to receive user inputs. The casing may further include a second portion configured to taper toward the input portion to form at least one beveled edge around the outward facing surface, the at least one beveled edge forming at least one waterproof seal with a covered portion of the device.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other novel features will become apparent from the following detailed description when considered in conjunction with the drawings and the disclosed aspects are intended to include all such aspects and their equivalents.

### BRIEF DESCRIPTION OF THE DRAWING

FIG. 1 shows a standard computer screen casing design (Prior Art).

FIG. 2 shows a beveled computer screen casing design.

FIG. 3 shows an enclosed computer cabling system.

FIG. 4 illustrates a cleaning agent tolerant casing design.

FIG. 5 illustrates a cleaning agent tolerant casing design to enable heat dissipation.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

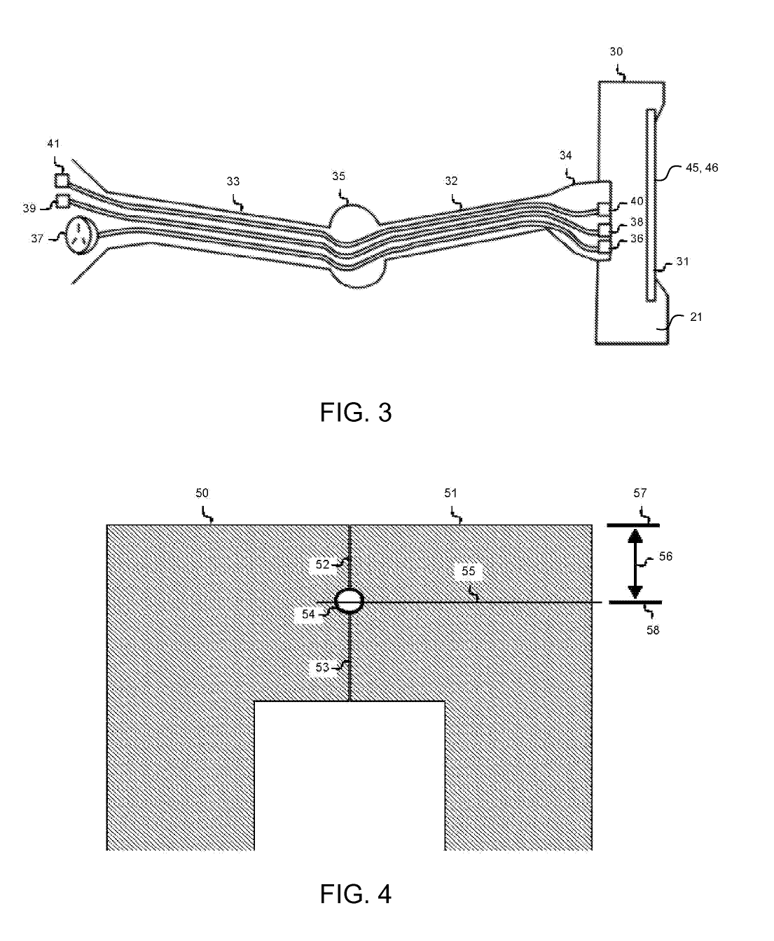

FIG. 3 shows a cross section view of a closed water resistant articulation arm that allows a touch screen 31 operated sterilize-able computer 30 to be suspended conveniently near a hospital patients bed. The arm consists of spring or pneumatic controlled sections 32 33 that also allow for cables to pass along inside the arms structure 32 33 and through one or many pivot points 35 to the wall surface where the cabling interfaces with the power circuit 37, the computer network 39 via network cabling such as Cat5, and peripheral connectors 41 that allow computer control of peripherals mounted on the wall nearby the patients bed.

Examples of a peripheral connection would be a USB cable connecting to a USB device. The computer 30 would have connection ports for power 36, network 38 and peripherals 40 amongst other connection types and these would be enclosed within a water and cleaning agent resistance shroud 34 that allows the cables to connect through the arm with the various ports on the wall. The arm is used to position the computing device 30 and touch screen 31 so that it is convenient for use by the patient, health workers and even visitors of the patient.

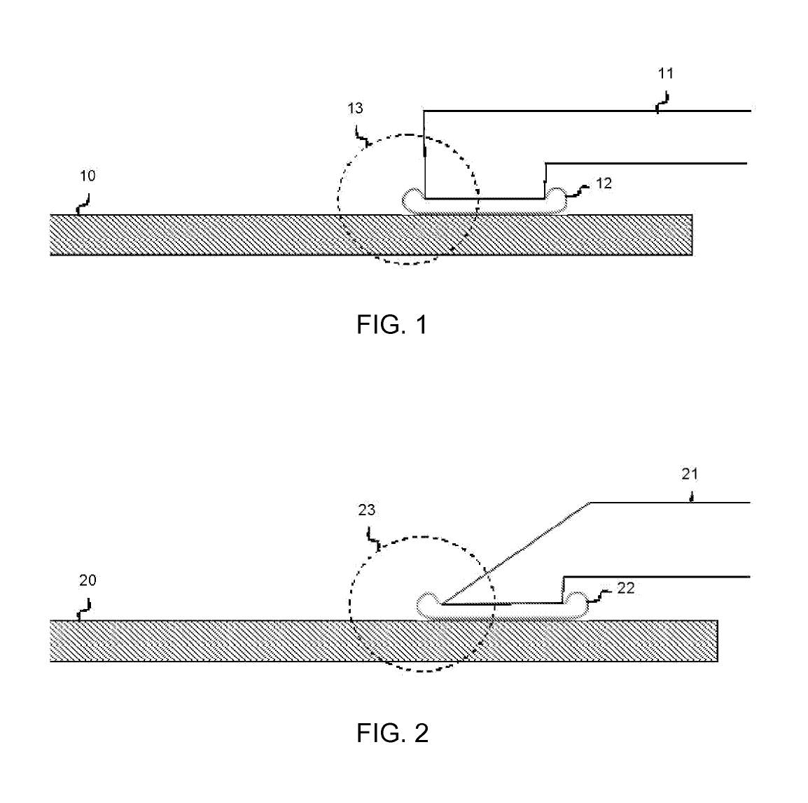

FIG. 1 shows a cross section blow up of the way that most screens and computer casings are positioned in the art. The screen 10 is attached to the computer casing 11 with a water and impact resistant cushion usually in the form of a gasket 12 that separates the hard surfaces of the screen 10 and the computer casing 11. The problem with this design in the art is that the area 13 where the gasket 12, the screen 10 and the casing 11 meet is hard to clean and prone to the collection of debris. In the case of a hospital this could lead to the buildup of highly dangerous infectious material with life threatening consequences and liability.

FIG. 2 illustrates an aspect of the example embodiment that allows the area 23 that meets the screen 20, gasket 22, and computer casing 21 to be more accessible due to a bevel of the computer casing 21. This allows easier access of cleaning equipment and penetration of cleaning sprays and detergents.

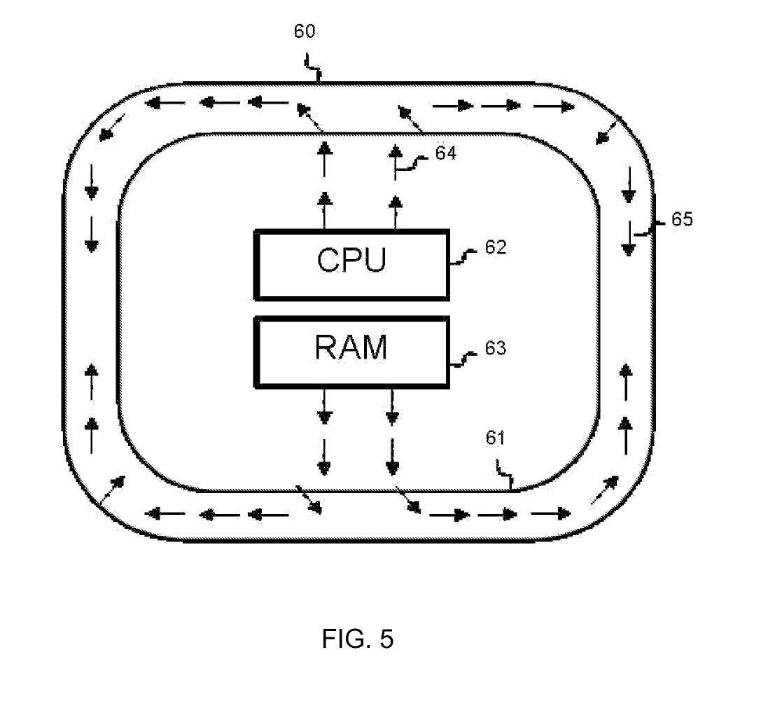

Another feature of the sterilize-able computer is the casing design shown in FIG. 4. Since the casing is used as a heat sink as explained in FIG. 5, it is important for the top 51 and bottom 50 parts of the casing to allow heat to transfer from one part of the computer casing to the other with maximum efficiency. The gap to the outside 52 of the o-ring sealer 54 and the inside 53 of the o-ring sealer 54 must allow maximum metal-to-metal contact to allow maximum heat transference and dissipation. The distance 56 from the outside of the casing 57 to the placement of the o-ring sealer 58 must be as small as possible to ensure a minimum of opportunities for infected debris to lodge in any gaps 52 that appear between the top 51 and bottom 50 parts of the casing.

The embodiments may also feature a heat dissipating casing design as described in FIG. 5. Heat dissipation is essential to a sterilize-able computer since the computer must be fully enclosed to avoid opportunities for infected debris to be collected in or around the computer. The CPU 62 and other major heat producing components such as RAM 63 are connected to the casing of the computer 60 using materials that are electrically nonconductive but allow heat transfer to occur efficiently to the casing 60 of the computer. The heat is drawn away from the component 64 and allowed to dissipate throughout the casing 65.

It is noted that other environments in which this design could provide advantage include dentist surgery, factory food processing, customs, pharmaceutical laboratories, biological laboratories, kitchens, ambulances, etc. It is further noted that alternatives or additions to the enclosed heat sink system may include a liquid cooling system with water or other fluid acting as heat transference medium. Another alternative embodiment may feature a fan with HEPA filter, a closed refrigerative system, or the use of spray cooling, or the like.

In accordance with aspects of the embodiments described herein, there is provided an apparatus for use in sterile environments and/or needs to protected from water and agents that may be in a given environment. With reference once again to FIG. 3, in one embodiment, there is shown an apparatus 30 for sterile environments, having a touch screen 31 comprising an outward facing surface 45. The apparatus 30 may include at least one processor (see, e.g., CPU 62 of FIG. 5) operatively coupled to the touch screen 31. The apparatus 30 may include a memory (see, e.g., RAM 63 of FIG. 5) coupled to the at least one processor for storing data. The apparatus 30 may include a casing 21 that is configured to: enclose the at least one processor and the memory; partially enclose the touch screen 31 while allowing an input portion 46 of the outward facing surface 45 to be outwardly exposed to receive user inputs; and taper toward the input portion 46 to form a beveled frame around the outward facing surface 45, the beveled frame forming at least one waterproof seal with a covered portion of the outward facing surface 45.

In related aspects, the apparatus 30 may further include at least one gasket (see, e.g., gasket 22 of FIG. 2) between the beveled frame of the casing 21 and the covered portion of the outward facing surface 45 of the touch screen 31. The apparatus 30 may further include a connector interface for receiving at least one connector (e.g., the connector interface may connection ports for power, networking, and peripherals).

In further related aspects, the connector interface may form a water and agent resistant seal with a water and agent resistant shroud (see, e.g., shroud 34 of FIG. 3) configured to enclose the at least one connector. The water and agent resistant shroud may be part of an articulation arm that allows the input portion 46 of the touch screen to be placed at a user-defined location (see, e.g., the water resistant articulation arm of FIG. 3).

In still further related aspects, the casing 21 may be further configured to dissipate heat by serving as a heat sink that transfers the heat from a first part to a second part of the casing 21 (see, e.g., the computer 60 of FIG. 6). For example, at least one of (a) the at least one processor and (b) the memory may be connected to the casing 21 with a non-conducting material to facilitate transfer of the heat to the casing 21. In another example, the apparatus 30 may further include at least one of a liquid cooling module, a fan module, a closed refrigerative module, and a spray cooling module.

In accordance with aspects of the embodiments described herein, there is provided a system (e.g., computer 30) that includes: a touch screen device (e.g., touch screen 31) comprising an outward facing surface 45; and a casing 21. The casing 21 may be configured to partially enclose the touch screen device 31 while allowing an input portion 46 of the outward facing surface 45 to be outwardly exposed to receive user inputs. The casing 21 may be further configured to taper toward the input portion 46 to form at least one beveled edge around the outward facing surface 45, the at least one beveled edge forming at least one waterproof seal with a covered portion of the outward facing surface 45.

In accordance with aspects of the embodiments described herein, there is provided a casing 21 that has a first portion configured to partially enclose a touch screen device 31 while allowing an input portion 46 of the device 31 to be outwardly exposed to receive user inputs. The casing 21 may have a second portion configured to taper toward the input portion 46 to form at least one beveled edge around the outward facing surface 45, the at least one beveled edge forming at least one waterproof seal with a covered portion of the device 31.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed:

1. An apparatus, comprising:
a touch screen comprising an outward facing surface;
at least one processor operatively coupled to the touch screen;
a memory coupled to the at least one processor for storing data; and
a casing configured to:
enclose the at least one processor and the memory;
partially enclose the touch screen while allowing an input portion of the outward facing surface to be outwardly exposed to receive user inputs; and
taper toward the input portion to form a beveled frame around the outward facing surface, the beveled frame forming at least one waterproof seal with a covered portion of the outward facing surface.

2. The apparatus of claim 1, further comprising at least one gasket between the beveled frame and the covered portion of the outward facing surface.

3. The apparatus of claim 1, further comprising a connector interface for receiving at least one connector.

4. The apparatus of claim 3, wherein the connector interface forms a water and agent resistant seal with a water and agent resistant shroud configured to enclose the at least one connector.

5. The apparatus of claim 4, wherein the water and agent resistant shroud is part of an articulation arm that allows the input portion of the touch screen to be placed at a user-defined location.

6. The apparatus of claim 1, wherein the casing is further configured to dissipate heat by serving as a heat sink that transfers the heat from a first part to a second part of the casing.

7. The apparatus of claim 6, wherein at least one of (a) the at least one processor and (b) the memory is connected to the casing with a non-conducting material to facilitate transfer of the heat to the casing.

8. The apparatus of claim 1, further comprising at least one of a liquid cooling module, a fan, a closed refrigerative module, and a spray cooling module.

9. A system, comprising:
a touch screen device comprising an outward facing surface; and
a casing configured to:
partially enclose the touch screen device while allowing an input portion of the outward facing surface to be outwardly exposed to receive user inputs; and
taper toward the input portion to form at least one beveled edge around the outward facing surface, the at least one beveled edge forming at least one waterproof seal with a covered portion of the outward facing surface.

10. The system of claim 9, further comprising at least one gasket between the at least one beveled edge and the covered portion of the outward facing surface.

11. The system of claim 9, further comprising a connector interface for receiving at least one connector, wherein the connector interface forms a water and agent resistant seal with a water and agent resistant shroud configured to enclose the at least one connector.

12. The system of claim 11, wherein the water and agent resistant shroud is part of an articulation arm that allows the input portion of the touch screen to be placed at a user-defined location.

13. The system of claim 9, further the casing is further configured to dissipate heat by serving as a heat sink that transfers the heat from a first part to a second part of the casing.

14. The system of claim 13, wherein the device is connected to the casing with a non-conducting material to facilitate transfer of the heat to the casing.

15. The system of claim 9, further comprising at least one of a liquid cooling module, a fan, a closed refrigerative module, and a spray cooling module.

16. An apparatus, comprising:
a first portion configured to partially enclose a touch screen device while allowing an input portion of the device to be outwardly exposed to receive user inputs; and
a second portion configured to taper toward the input portion to form at least one beveled edge around the outward facing surface, the at least one beveled edge forming at least one waterproof seal with a covered portion of the device.

17. The apparatus of claim 16, further comprising a connector interface for receiving at least one connector, wherein the connector interface forms a water and agent resistant seal with a water and agent resistant shroud configured to enclose the at least one connector.

18. The apparatus of claim 17, wherein the water and agent resistant shroud is part of an articulation arm that allows the input portion of the touch screen to be placed at a user-defined location.

19. The apparatus of claim 16, further the apparatus is configured to dissipate heat by serving as a heat sink.

20. The apparatus of claim 16, wherein the device is connected to the casing with a non-conducting material to facilitate transfer of the heat to the casing.
